(19) United States
(12) Patent Application Publication
(10) Pub. No.: US 2013/0325368 A1
(43) Pub. Date: Dec. 5, 2013

(54) SYSTEM FOR MONITORING AIR FLOW EFFICIENCY

(71) Applicant: Robert Edwin ROBB, El Centro, CA (US)

(72) Inventor: Robert Edwin ROBB, El Centro, CA (US)

(21) Appl. No.: 13/488,103

(22) Filed: Jun. 4, 2012

(51) Int. Cl. G01P 5/00; G06F 11/30

(52) U.S. Cl. CPC G01P 5/00; G06F 11/3058
USPC 702/45; 29/592.1

(57) ABSTRACT

A system for monitoring the service life of an HVAC air filter is disclosed and includes an airflow sensor that is positioned in an HVAC duct in relatively close proximity to the air filter. The airflow sensor output is sent to a processor that is pre-programmed with a filter evaluation algorithm. Each time the HVAC blower is activated begins a new duty cycle during which airflow signals are generated are sampled by the processor/algorithm. Selected sampled values are averaged to calculate a peak airflow velocity, Vₚₑₐₖ, for each duty cycle. The peak airflow velocity, Vₚₑₐₖ, is then compared to a base reference, V_{reference}, to determine whether the air filter requires service/replacement. The value of the base reference, V_{reference}, can be established during an initializing procedure and thereafter updated using the peak airflow velocity, Vₚₑₐₖ.

### FIELD OF THE INVENTION

The present invention pertains generally to devices and methods for efficiently filtering air in heating, ventilation and air conditioning (HVAC) systems. More particularly, the present invention pertains to air filter monitors for HVAC systems. The present invention is particularly, but not exclusively, useful for monitoring an HVAC air filter to determine whether the air filter needs servicing or replacement.

### BACKGROUND OF THE INVENTION

Nearly all commercial and residential buildings have an HVAC system that includes an air handler to condition and circulate air within the building. Moreover, all of these systems include at least one air filter to filter the circulating air. Generally, the HVAC systems include tubular structures (ducts) to deliver and remove air from the building. Air filters are often placed in a duct upstream of the system's blower (return duct) to remove dust and other particles from the building before the air is recirculated.

Many types of air filters are commercially available including cloth filters, single use, disposable, fibrous media filters, washable metal screen filters, etc., and all or these filters have one thing in common. When they get dirty, they lower the overall efficiency of the system. For example, dirty filters can cause the blowers to work harder and use more energy than normal. In addition, dirty filters can cause HVAC components to undesirably heat to temperatures where they become inefficient.

Most HVAC systems are thermostatically controlled. In many of these systems, the blower runs intermittently, and generally only when needed. The consequence of this is that the conditions within the ducts and near the filter can vary considerably. In particular, pressures and flow velocities within the system can vary. Factors causing these conditions to vary include the temperature and moisture content of the air in the building and, in some cases, the outdoor air. In addition, these factors can include the overall dirt and particle levels in the building. Also, at any given time, the conditions in the system ducts are dependent on the length of time that the blower, heater, etc. have been operating and the previous cyclical operation of these components.

As indicated above, a clogged filter can decrease system efficiency and waste energy. Crude methods for determining a filter's condition include holding the filter in front of a light source and visually determining how much light passes through the filter. This technique can be grossly unreliable. Rather than a visual inspection, another technique involves simply replacing a filter, without inspection, according to a periodic replacement schedule, e.g. monthly or yearly. Unfortunately, both of these techniques are inefficient, and can result in either 1) an otherwise usable filter being discarded, or, 2) the inefficient use of a clogged filter that should have been replaced earlier.

As disclosed herein, the airflow velocity near a filter can provide an indication of filter cleanliness. However, in some cases, due to the varying conditions that can be present in the ducts as described above, simple airflow measurement techniques can provide inaccurate results. For example, a reference airflow may be determined under an initial set of duct conditions. Later, a filter measurement may be made and compared to the reference to gauge filter cleanliness. However, if the two measurements are made under substantially different duct conditions, a relative clean filter may appear to be dirty, or vice versa.

With the above in mind, it is an object of the present invention to provide a system and method for accurately monitoring an HVAC filter to determine whether an air filter needs servicing. It is another object of the present invention to provide a system and method for accurately monitoring an HVAC filter to estimate a period of time before an air filter needs to be replaced. Another object of the present invention is to provide systems and methods for monitoring air flow efficiency that are relatively easy to manufacture, simple to use and is comparatively cost effective.

### SUMMARY OF THE INVENTION

A system for monitoring the service life of an HVAC air filter includes an airflow sensor that is positioned in an HVAC duct in relatively close proximity to the air filter. For the system, the airflow sensor outputs signals that are indicative of the airflow velocity of air flowing through the duct. These airflow signals are then sent to a processor. In accordance with the invention, the processor is pre-programmed with a filter evaluation algorithm. The processor inputs the airflow signals into the filter evaluation algorithm and runs the algorithm to determine whether the air filter requires replacement. For the system, an indicator can be operationally connected to the processor to generate a user perceptible output such as an audio alarm or a visual display when the filter requires servicing or replacement.

As indicated above, the processor/algorithm performs operations on the airflow signals to determine whether the air filter requires service/replacement. In one implementation, airflow through the duct occurs periodically. Each time the HVAC blower is activated begins a new duty cycle that is typically longer than about three minutes. During a duty cycle, the airflow signals that are generated are sampled by the processor/algorithm. This sampling can include one or more reading cycles within each duty cycle. In addition, for each reading cycle, a specific sampling plan may be conducted. For example, for each reading cycle, the processor/algorithm may sample the airflow signals at approximately four second intervals for a period of about eighty seconds. Typically, the first reading period is conducted within three minutes from the beginning of a new duty cycle. The number of reading periods per duty cycle and the temporal spacing between reading periods can also be included in the sampling plan.

The result of the sampling plan described above is a number of digitized airflow velocity values (i.e. magnitudes) that can be manipulated by the processor/algorithm to determine whether the air filter requires service/replacement. More specifically, for each duty cycle, this manipulation can include the step of determining a maximum airflow velocity value, Vₘₐₓ, for each reading period in the duty cycle. The algorithmic manipulation can further include the step of averaging the maximum airflow velocity values, Vₘₐₓ, to determine a peak value Vₚₑₐₖ, for each duty cycle. Once the peak value Vₚₑₐₖ, is calculated for a duty cycle, the processor/algorithm can compare the peak value Vₚₑₐₖ, to a base reference, V_{reference}, to determine whether the air filter requires service/replacement. For example, the processor/algorithm may provide an alarm output indicating a dirty filter when the peak value Vₚₑₐₖ, is less than a preselected percentage, P of said base value V_{reference} (i.e. Vₚₑₐₖ<P×V_{reference}). Typically, suitable values of P are in the range of about 70 to 90 percent.

For the present invention, the value of the base reference, V_{reference} can be established during an initializing step when the filter is new or the base reference, V_{reference}, can be established during normal HVAC system operation. In either case, the base reference, V_{reference} can be held constant over the life of the filter or can be updated by the processor/algorithm. In one embodiment of the algorithm, the base reference, V_{reference} is updated by comparing the current base reference, V_{reference} with the most recently calculated peak value Vₚₑₐₖ, and updating the base reference, V_{reference} with the peak value Vₚₑₐₖ, when the peak value Vₚₑₐₖ, exceeds the base reference, V_{reference}.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of a portion of a building environment showing a system for monitoring the service life of an HVAC air filter operationally positioned in an HVAC unit;

FIG. 2 a schematic view showing the components of a system for monitoring the service life of an HVAC air filter;

FIG. 3A shows a perspective view of a one-piece system for monitoring the service life of an HVAC air filter having a fan-style airflow sensor, circuitry portion having a processor for running a preprogrammed algorithm and a battery section, shown folded in an operational configuration;

FIG. 3B shows a top plan view of a one-piece system shown in FIG. 3A folded into a compact configuration for storage or transport;

FIG. 4 is a flowchart illustrating the algorithmic steps for determining whether an air filter requires service/replacement in accordance with one aspect of the present invention;

FIG. 5 shows a plot of the analog signal output from an airflow sensor on a graph of voltage versus time and illustrates a plan for sampling the output; and

FIG. 6 shows a plot of voltage versus time in which each dot represents a calculated Vₚₑₐₖ value for a duty cycle and illustrates a method for updating a reference voltage that is used to gauge whether a filter should be serviced or replaced.

### DESCRIPTION OF THE PREFERRED EMBODIMENTS

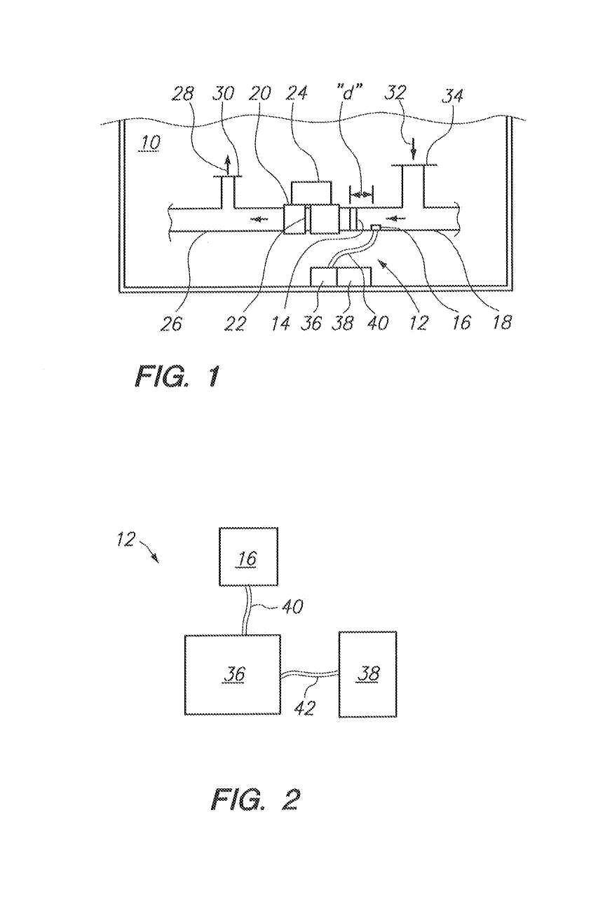

Referring initial to FIG. 1, a portion of a building environment 10 is shown having an HVAC unit and a system (generally designated 12) for monitoring the service life of an HVAC air filter 14. As shown, the system 12 includes an airflow sensor 16 that is positioned in an HVAC duct 18 at a distance “d” along the duct 18 from the air filter 14. For the arrangement shown in FIG. 1, the HVAC unit includes and air handler 20 having a blower 22 which may be operationally coupled with an optional heating, air conditioning, humidifier and/or dehumidifying subsystem(s) 24. As shown, air is forced to circulate into and through duct 26 by blower 22. Air in duct 26 is then introduced (arrow 28) into a space or room in the building environment 10 through vent 30. Also shown, air returns (arrow 32) from a space or room flowing into return duct 18 through vent 34. From vent 34, air flows through duct 18, past sensor 16, and through filter 14 to the air handler 20.

Cross-referencing FIGS. 1 and 2, it can be seen that the system 12 includes a processor that is pre-programmed with a filter evaluation algorithm (processor/algorithm 36) and an input/output device 38. As shown, the sensor 16 is electronically connected with the processor/algorithm 36 via link 40 which can be, for example, a wire or wires, a wireless connection, a bus or the two can be connected over a network such as an internet connection. The processor/algorithm 36 and sensor 16 may be integrated (sharing one or more components), co-located or the processor/algorithm 36 may be remotely located from the sensor 16. Also, shown, the input/output device 38 is electronically connected with the processor/algorithm 36 via link 42 which can be, for example, a wire or wires, a wireless connection, a bus or the two can be connected over a network such as an internet connection. The processor/algorithm 36 and input/output device 38 may be integrated (sharing one or more components), co-located or the processor/algorithm 36 may be remotely located from the input/output device 38. Thus, for the present invention, the entire system 12 may be one integral unit located within a duct 18, or, a sensor may be position in the duct 18 having a link (wireless or wire) to outside the duct 18, with the other system 12 components located in close proximity, remotely or a combination thereof.

For the system 12, the airflow sensor 16 outputs signals that are indicative of the airflow velocity of air flowing through the duct 18. Suitable airflow sensor include, but are not limited to, fan-type sensors having a blade which rotates in an airflow and coils/magnets which generate an electrical output that is proportional (linearly or non-linearly proportional) to the blades RPM. Alternatively, flaps may be used which pivot to an extent that is proportional (linearly or non-linearly proportional) to an airflow velocity. Flow meters based on Bernoulli's principle such as single static air pressure sensor may be used. Typically, these sensors output an electrical signal have a voltage or amplitude that is proportional (linearly or non-linearly proportional) to an airflow velocity. Any other type of airflow sensor known to those skilled in the pertinent art which outputs an electrical signal having at least one signal parameter such as voltage or amplitude that is proportional (linearly or non-linearly proportional) to an airflow velocity can be used in the system 12.

The airflow sensor 16 is typically mounted in a return duct 18 upstream of the air filter 14 at a location in the cross-section of the duct 18 where laminar flow is most likely to occur. In some cases, as shown in FIG. 1, the airflow sensor 16 is positioned in duct 18 at a distance “d” along the duct 18 from the air filter 14. Typically, this distance “d” is approximately six to eight inches. In some cases, a service access (not shown) is provided about 1 foot from the filter. In these cases, the airflow sensor 16 can be conveniently positioned between the service access and filter. Several techniques can be used to mount the airflow sensor 16 in the duct 18 including, but not limited to, sheet metal screws, two sided tape or a magnetic mount.

Also for the system 12, the processor/algorithm 36 can include a processor such as a microcomputer (programmable or programmed), personal computer, logic circuit or a combination thereof, with memory, or any other device known to those skilled in the pertinent art capable of processing instructions and implementing the algorithms described herein. The algorithms described may be programmed into hardware, firmware, software or a combination thereof. The processor/algorithm 36 may be pre-programmed with the algorithm prior to delivery of the system 12 to the user and/or may be programmed with an algorithm that is updatable or accepts/requires user input (see below). Typically, the algorithm is programmed into an application level software program which is translated into machine language and processed by a microprocessor or personal computer.

Also for the system 12, the input/output device 38 can include one or more output devices including speakers for audio output and/or displays for displaying visual information. For example, the speakers can be provided for producing an audible alarm such as a siren, buzz and/or screech, or may produce spoken status reports such as “battery low”; “filter change needed”, etc. The display may be as simple as a light (e.g. LED), a panel of lights or a multi-pixel display. The LED's may indicate state such as initialization, low airflow, low battery, etc. An onboard or detachable LCD may be used to display information such as “battery low”; “airflow drop {appropriate percent}” filter life left {appropriate life time}, etc. The output may be a touchscreen or computer monitor. Some or all of the system 12 may be connected to a network such as a LAN, the internet, etc. In this case, the output may include email notifications or an update to a website. For the system 12, the input/output device 38 can include one or more input devices which can include, for example, input buttons such as a single button to check battery life, a multi-button panel, a five point, round and center panel allowing menu navigation, for example, if an LCD is present, etc. Other known forms of input devices such as touchscreens, keyboards, a mouse, a bluetooth device such as a cellphone, infra-red remote control, etc. can be used as an input to the system 12.

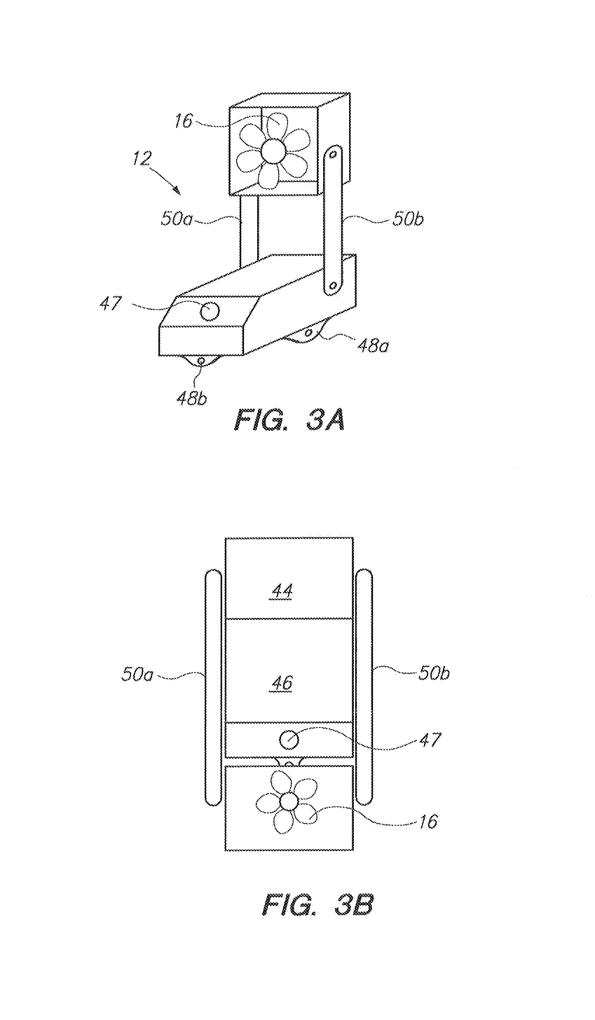

FIGS. 3A and 3B show a one-piece system 12 having a fan-style airflow sensor 16, circuitry portion 44 having a processor for running a preprogrammed algorithm and a battery section 46. As shown, the system 12 includes an LED lamp 47 for indicating whether filter replacement/service is required. Screw mount holes 48a,b are provided to screw the unit to a duct wall. Folding arms 50a,b allow the fan portion to pivot between a stowed configuration (FIG. 3B) and an operational configuration (FIG. 3A).

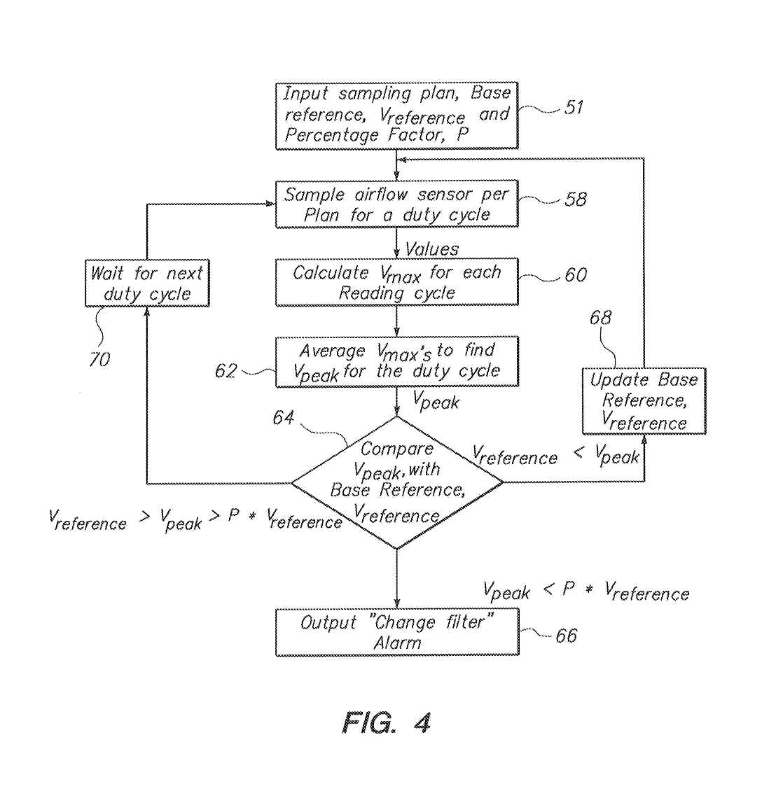

FIG. 4 is a flowchart illustrating algorithmic steps for determining whether an air filter requires service/replacement. As shown, the process can begin by inputting a sampling plan (Box 51) for sampling the signal output from an airflow sensor, an initial base reference V_{reference}, and a percentage factor, P. The sampling plan, base reference V_{reference}, and/or percentage factor, P can be pre-programmed into the processor/algorithm 36 or, in some cases, the one or more of these items can be created and/or modified by the user, for example, using an I/O device 38 described above. When a new filter is used, an initialization process may be used to ensure the new filter is performing correctly. This process can include calculating a maximum airflow velocity value, V_{max-empty}, for a reading period without a filter installed in the HVAC unit. The new filter can then be installed and a maximum airflow velocity value, V_{max-new}, for a reading period can be measured. The measured maximum airflow velocity value, V_{max-new}, can then be compared with the value, V_{max-empty} to determine whether the new filter is performing correctly within initial specifications for the filter. For example, a new filter may be determined to be out of specification if the value, V_{max-new}, is less than a preselected percentage, P_{new} of the value, V_{max-empty} (i.e. V_{max-new}<P_{new}×V_{max-empty}). For example, a suitable value of P_{new} may be in the range of about 85 to 95 percent.

FIG. 5 illustrates a plan for sampling an analog signal 52 from an airflow sensor 16 (see FIG. 1). The analog signal 52 shown in FIG. 5 represents the signal output of an airflow sensor 16 for an illustrative duty cycle. As shown, the dots 54 in FIG. 5 represent sampling events and corresponding voltage values. The processor/algorithm 36 samples the analog signal 52 at specific times, t, according to a pre-programmed sampling plan. For this purpose, the processor/algorithm 36 can include a clock and logic for sampling the analog signal 52 according to the pre-programmed sampling plan. As shown, the sampling plan can include sampling within a number of reading cycles 56a-c within the duty cycle. In addition, for each reading cycle 56a-c, a specific sampling plan may be conducted. FIG. 5 illustrates three reading cycles 56a-c, in each of which the analog signal 52 is sampled at approximately four second intervals for a period of about eighty seconds (twenty samples per reading cycle). Typically, the first reading cycle 56a-c is conducted within three minutes from the beginning of a new duty cycle. The number of reading periods per duty cycle and the temporal spacing between reading periods can also be included in the sampling plan.

The result of the sampling step (Box 58) shown in FIG. 4 are a set of digitized airflow velocity values corresponding to each sampling event. Box 60 of FIG. 4 shows that the next step is to determine the maximum airflow velocity value, Vₘₐₓ, for each reading period. This corresponds to dots 54a, 54b and 54c in FIG. 5. For example, a simple compare and replace algorithm which compares each new value with the previous maximum value and includes a counter to stop at the end of a reading cycle can be used.

Box 62 of FIG. 4 shows that the next step is to average the maximum airflow velocity values, Vₘₐₓ, to determine a peak value Vₚₑₐₖ, for each duty cycle. Typically, this can be implemented as a call to an averaging subroutine. Next, as shown in Box 64, the peak value Vₚₑₐₖ, is compared to a base reference, V_{reference}. As shown, when the peak value Vₚₑₐₖ, is less than a preselected percentage, P of the base reference V_{reference} (i.e. Vₚₑₐₖ<P×V_{reference}), the system 12 outputs an alarm, warning light, etc. (Box 66). On the other hand, when V_{reference}<Vₚₑₐₖ, the base reference can be update (Box 68) and the updated V_{reference} used for the next duty cycle. Lastly, when V_{reference}>Vₚₑₐₖ>P×V_{reference}, the system waits for the next duty cycle (Box 70) and repeats Boxes 58-70, as applicable with the current base reference V_{reference} and new airflow sensor analog signal. Typically, a value of P in the range of about 70 to 90 percent is used.

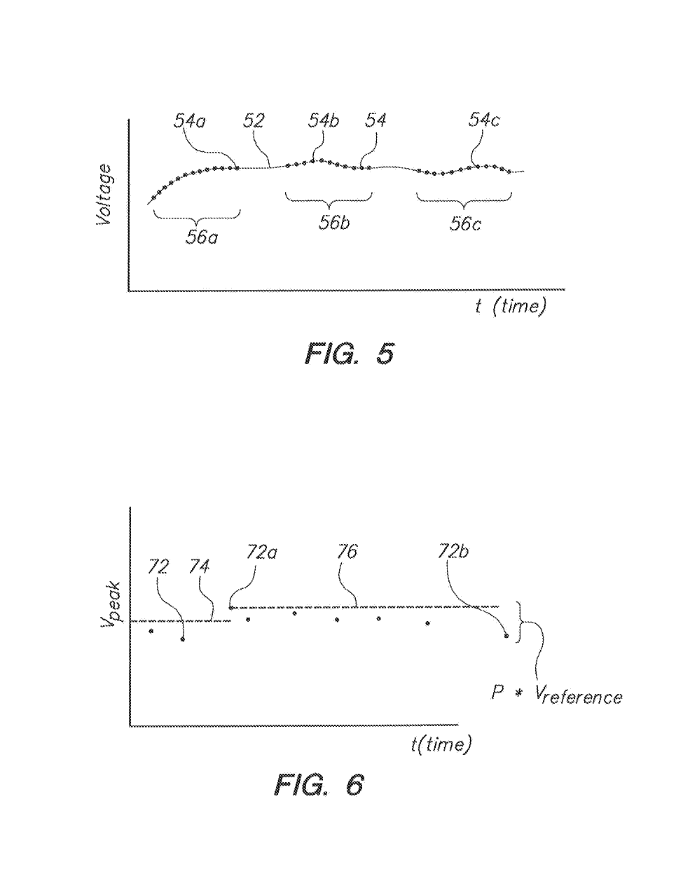

FIG. 6 further illustrates the decision Box 64 of FIG. 4. More specifically, each dot 72 in FIG. 6 represents a calculated Vₚₑₐₖ value for a duty cycle. Dots 72 for the last nine duty cycles at the end of a filter's life are shown. Also, an initial base reference V_{reference} is illustrated by dotted line 74 and an updated base reference V_{reference} is illustrated by dotted line 76. As shown, the earliest two Vₚₑₐₖ values are slightly below the initial base reference V_{reference} (dotted line 74). For these two, the algorithm does not activate the alarm (Box 66) or update the Base reference (Box 68). However, the third dot 72a represents a Vₚₑₐₖ value above the initial base reference V_{reference} (dotted line 74) so the base reference V_{reference} is updated (Box 68) and an updated Base Reference (dotted line 74) is used for future duty cycles. The next five Vₚₑₐₖ values are slightly below the updated base reference, V_{reference} (dotted line 76). For these five, the algorithm does not activate the alarm (Box 66) or update the Base reference (Box 68). The last Vₚₑₐₖ value (dot 72b) is less than P*V_{reference} so the algorithm activates the alarm (Box 66).

In an alternate embodiment, the algorithmic output of Box 64 can be used to drive an automated filter changing and/or filter cleaning apparatus. For example, U.S. Pat. No. 6,152,998 granted on Nov. 28, 2000, and titled AUTOMATIC FILTER CARTRIDGE to James Eric Taylor, discloses an automatic filter cartridge having a supply roller and takeup roller. As disclosed, a motor can be used to rotate the take-up roller and replace a dirty portion of a filter roll with a clean portion.

The algorithm shown in FIG. 4 can be modified or augmented to generate and output other process parameters including a total cumulative run time for the air filter and an estimated time for a replacement of the air filter. For example, in the calculation of an estimated time for a replacement of the air filter, an empirical or theoretically derived relationship between the quantity (V_{reference} minus Vₚₑₐₖ) and the estimated time for a replacement of the air filter can be used.

While the particular System for Monitoring Air Flow Efficiency as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for monitoring the serviceability of an air filter which comprises the steps of:
causing air to flow through a duct over a duty cycle;
positioning an airflow sensor in the duct to generate an airflow reading in response to the flow of air through the duct, wherein the airflow reading is indicative of airflow velocity;
placing the air filter in the duct;
monitoring the airflow sensor during at least one individual reading period in the duty cycle to identify a maximum value for airflow velocity during each reading period;
averaging the maximum values obtained during the monitoring step to determine a peak value for the duty cycle;
establishing a base reference for the serviceability of the air filter;
comparing the peak value of the duty cycle with the base reference to determine whether the air filter requires replacement.

2. A method as recited in claim 1 wherein the establishing step is accomplished by evaluating the peak value in the duty cycle with the highest peak value of previous duty cycles, and thereafter using the higher peak value as the base reference.

3. A method as recited in claim 2 wherein the comparing step includes the step of determining a replacement of the air filter is required when the peak value of the duty cycle is below a preset percentage of the base reference.

4. A method as recited in claim 3 wherein the preset percentage is eighty percent (80%).

5. A method as recited in claim 1 wherein approximately twenty separate airflow readings are taken in each reading period, and wherein the airflow readings are individually taken at approximately four second intervals.

6. A method as recited in claim 5 wherein a reading period is conducted within the first three minutes of a duty cycle.

7. A method as recited in claim 6 wherein a duty cycle is greater than three minutes.

8. A method as recited in claim 1 wherein the positioning step includes the step of locating the airflow sensor within a predetermined distance from the air filter.

9. A method as recited in claim 8 wherein the predetermined distance is within an approximate range between six to eight inches.

10. A method as recited in claim 1 further comprising an initializing step, wherein the initializing step is accomplished using the steps of causing, positioning, monitoring and averaging, and further wherein the initializing step is accomplished prior to accomplishing the steps of placing, establishing and comparing.

11. A method as recited in claim 1 further comprising the step of displaying operational parameters of the method, to include a total cumulative run time of the monitoring step and an estimated time for a replacement of the air filter.

12. A method as recited in claim 1 wherein the airflow sensor is selected from a group comprising a fan and a flapper.

13. A system for monitoring the serviceability of an air filter in a duct, the system comprising:
an airflow sensor positionable in the duct to generate periodic airflow reading signals during a reading period, wherein the airflow readings signals are indicative of airflow velocity of air flowing through the duct;
an indicator providing a user perceptible output; and
a processor for receiving said airflow reading signals and having logic to identify a maximum values for airflow velocity during a plurality of reading periods, logic for averaging said maximum value to determine a peak value, and logic for comparing said peak value to a base reference to signal said indicator when the peak value is less than a preselected percentage of said base value.

14. A system as recited in claim 13 wherein the processor further comprises logic for comparing the peak value to the base reference to update a base reference when the peak value is higher than the base reference.

15. A system as recited in claim 13 wherein the airflow sensor is selected from a group comprising a fan and a flapper.

16. A system as recited in claim 13 wherein the indicator comprises a display for providing a user with operational parameters including a total cumulative run time of the air filter and an estimated time for a replacement of the air filter.

17. A system for monitoring the serviceability of an air filter comprising:
means for causing air to flow through a duct over a duty cycle;
an airflow sensor disposed in the duct to generate an airflow reading in response to the flow of air through the duct, wherein the airflow reading is indicative of airflow velocity;
an air filter operationally positioned in the duct;
means for monitoring the airflow sensor during at least one individual reading period in the duty cycle to identify a maximum value for airflow velocity during each reading period;
means for averaging the maximum values obtained during the monitoring step to determine a peak value for the duty cycle;
means for establishing a base reference for the serviceability of the air filter; and
means for comparing the peak value of the duty cycle with the base reference to determine whether the air filter requires replacement.

18. A system as recited in claim 17 wherein the airflow sensor is positioned within an approximate range between six to eight inches from the air filter.

19. A system as recited in claim 17 wherein the airflow sensor is selected from a group comprising a fan and a flapper.

20. A system as recited in claim 17 further comprising an indicator providing a user perceptible output when the air filter requires replacement.
